(19) United States
(12) Patent Application Publication
(10) Pub. No.: US 2008/0088866 A1
(43) Pub. Date: Apr. 17, 2008

(54) INFORMATION COMMUNICATION SYSTEM

(75) Inventor: Satoshi Awata, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 11/871,308

(22) Filed: Oct. 12, 2007

(30) Foreign Application Priority Data
Oct. 13, 2006 (JP) 2006-279554

(51) Int. Cl. G06F 15/00

(52) U.S. Cl. 358/1.13

(57) ABSTRACT

An information communication system is provided, which, through the use of a standard network technology, links a server terminal to an information apparatus, and allows the use of application software and data stored on another server terminal. A web server terminal includes a main program running in response to logging in from the information apparatus, and a subprogram running in response to direct logging in from the web server terminal and requiring user authority different from that for the main program. The main program receives and delivers information using internet server software that is limited in access to another server terminal connected by network connection, and the subprogram is allowed to make access to another server terminal without using the internet server software. When the main program is incapable of obtaining information stored on another server terminal, the subprogram is entrusted with obtainment of the information.

### CROSS-NOTING PARAGRAPH

This Nonprovisional application claims priority under 35U.S.C. §119 (a) on Patent Application No. 2006-279554 filed in JAPAN on Oct. 13, 2006, the entire contents of which are hereby incorporated herein by references.

### FIELD OF THE INVENTION

The present invention relates to an information communication system that allows an information apparatus, such as a digital copier, to use application software stored on a web server terminal via network connection.

### BACKGROUND OF THE INVENTION

These years, a digital multi-function peripheral (MFP), etc., has come to have an extremely high processing function and network function, but is still used in the capacity of such peripheral equipment for a personal computer as printer and scanner. Meanwhile, corporate office work management sections introduce various pieces of business application software including document making/management software utilizing IT technology, making efforts for improving business efficiency. This situation has led to a discussion on connecting an information office work apparatus, such as MFP, to business application software via a network to improve total business efficiency.

An information apparatus, such as MFP, is usually connected to an in-house network (LAN) for use, and application software is stored on a server terminal and is connected to the LAN. The information apparatus and the server terminal exchange information data, and this data exchange is usually carried out on the basis of a standard network technology. Using the standard network technology enables the use of ordinary tools in application development, thus allowing efficient application development. Using the standard network technology also enables the use of memories, HDDs, etc., on the server terminal side in application development, which reduces restrictions on the development to allow the development at high degree of freedom.

A technique enabling a plurality of MFPs to use application software stored on one server terminal has been developed (e.g., see Japanese Laid-Open Patent Publication No. 2006-39647). This technique reduces maintenance work to updating of the application only, thus facilitates maintenance work.

When the standard network technology is used to link the server terminal to the information apparatus, for example, Internet Information Services (IIS) is used. The IIS is one kind of internet server software, having a function of performing environment setting that allows access to a data base, etc., without making any particular application software. The IIS is provided with an interface capable of causing a program to run at high speed at the server terminal side. In running a program using the IIS, an external information apparatus exchanges data with the server terminal through a standard input/output means, so that the program can be run at high speed through direct contact with the program, which allows further flexible program development.

The above internet server software, however, is a Microsoft product, and the original specification of this software prevents access to another server terminal. When the information apparatus, such as MFP, uses a program on the server terminal by using the internet server software, therefore, the information apparatus may be unable to access another server terminal connected to the network. In this case, desired useful information present in another server terminal cannot be obtained. Besides, the setup of a printer driver, etc., incorporated in the server terminal cannot be changed through logging in from a printer unit, such as MFP. As a result, a print job is always executed according to default print setting.

### SUMMARY OF THE INVENTION

The object of the present invention is to provide an information communication system that, through the use of a standard network technology, links a server terminal to an information apparatus and that allows the use of information stored on another server terminal.

An information communication system of the present invention is the information communication system that allows an information apparatus to use a program stored on a web server terminal via network connection. The web server terminal includes a main program running in response to logging in from the information apparatus, and a subprogram running in response to direct logging in from the web server terminal and requiring user authority different from that for the main program. The main program receives and delivers information using internet server software that is limited in access to another server terminal connected by network connection, and the subprogram is allowed to make access to another server terminal without using the internet server software. When the main program is incapable of obtaining information stored on another server terminal, the subprogram is entrusted with obtainment of the information.

Entrustment of information obtainment to the subprogram is executed as the entrustment is input through the information apparatus and is imparted from the main program to the subprogram. The information from another server terminal obtained via the subprogram is sent from the subprogram through the main program to the information apparatus, which uses the information. The information from another server terminal obtained via the subprogram may be stored on a memory.

When the main program of the web server terminal is incapable of obtaining the information stored on another server terminal, the subprogram is entrusted with obtainment of a subfolder name list and a file name list from another server terminal, or with a print process on a file from another server terminal. For entrustment of information obtainment from the main program to the subprogram, an XML file is used. The subprogram of the web server terminal is run under authority of a user directly logging into the subprogram, and is automatically stationed on a permanent basis on the web server terminal as the main program is started.

### BRIEF DESCRIPTION OF THE DRAWINGS

FIG. 1 is a block diagram for explaining the outline of the present invention;

FIG. 2 is a flowchart for explaining the outline of the present invention;

FIGS. 3A and 3B depict examples of display of a file name list, etc., on an MFP panel in the present invention;

FIGS. 4A to 4C depict examples of format display in a case of obtaining a folder name list;

FIGS. 5A to 5C depict examples of format display in a case of obtaining a file name list; and

FIG. 6 depicts an example of format display in a case of giving a file print instruction.

### PREFERRED EMBODIMENTS OF THE INVENTION

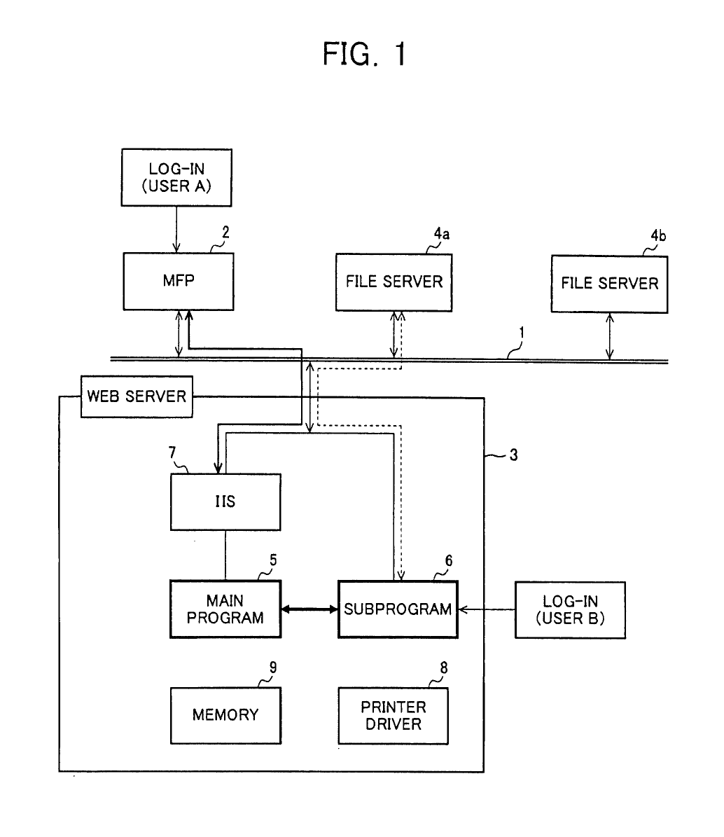

An embodiment of the present invention will be described with reference to FIG. 1. In FIG. 1, 1 denotes a network, 2 denotes an information apparatus (MFP), 3 denotes a web server terminal, 4a and 4b denote file server terminals, 5 denotes a main program, 6 denotes a subprogram, 7 denotes internet server software (e.g., IIS), 8 denotes a printer driver, and 9 denotes a memory.

An information communication system of the present invention is composed of, for example, the information apparatus 2, such as digital multi-function peripheral (MFP), the web server terminal 3, and a plurality of server terminals 4a and 4b (e.g., file server terminals), the information apparatus 2, web server terminal 3, and server terminals 4a and 4b being connected to the network 1, such as wired or wireless LAN and the Internet. The information apparatus 2 is provided as, for example, a digital multi-function peripheral (MFP) that serves as an office work apparatus to combine a copy function, a printer function, fax function, etc. The information apparatus 2, however, may be provided as a dedicated copier (monochrome or color), a dedicated printer, an office work terminal (personal computer), etc.

The web server terminal is a terminal apparatus, such as personal computer, that transmits information through such a network as the Internet, which means, for example, that the web server terminal is a terminal equipped with software having a function of transmitting information via the Web (www). The web server of this web server terminal 3 is also called, for example, internet information server (IIS: Internet Information Services), accumulates and saves information of various documents, images, etc., and transmits such information through the network 1 in response to a request from the information apparatus 2 (client software). In recent years, some web servers have a dynamic page generation function and a transaction process function linked to a data base, which functions are kept in storage in the form of information to accumulate.

Use of the web server provided as the IIS, which is one kind of the standard internet server software described above, links the information apparatus 2, such as MFP (hereinafter, the information apparatus 2 will simply be called MFP), to the server terminal without using special application software, thus enables environment setup that allows access to information, data base, etc., in the server terminal. Use of the IIS, however, limits access to other file server terminals 4a and 4b connected to the same network to which the server terminal is connected while allowing free transmission of information and data base from the server terminal to the MFP 2. As a result, a user may be unable to obtain desired useful information even if the user knows that the information is present in other file server terminals 4a and 4b.

The file server terminals 4a and 4b are defined as other server terminals to the web server terminal 3, and each of the file server terminals 4a and 4b has stored thereon information of specific documents, images, etc., to be transmitted. Each of the file server terminals 4a and 4b, however, may be provided as the above web server terminal or as a PC terminal having a function of transmitting contained information to the outside. Here, the file server terminals 4a and 4b are referred to as “file server terminal” merely for convenience in description.

According to the present invention, the web server terminal 3 of FIG. 1 includes, for example, a main program 5 to which access is made via an IIS 7 to cause the main program 5 to transmit information, and a subprogram 6 to which access is made not via the IIS 7 but through a separate interface and which is capable of accessing other server terminals to obtain information. The web server terminal 3 also may include, for example, the printer driver 8 having a function of assigning given print setting to the MFP 2, and the memory 9 that has stored thereon information that is obtained from the file server terminals 4a and 4b through the subprogram 6.

The main program 5 contains main application software, etc., used at the MFP 2, such as document making/document management software, image data, and operation screen display patterns. A user A operating the MFP 2 logs into the main program 5 through the network 1 and via the IIS 7, which is equivalent to a gateway to the web server terminal 3, and then runs the main program 5 after having logged into the program 5. In logging into the main program 5, the user A and the MFP 2 are authenticated based on authentication data information pre-registered on the terminal 3, and are authorized in access. This means that the user A has a user authority for operation of the main program 5.

On the other hand, the subprogram 6 has a function of accessing another server terminal to obtain information stored on the server terminal. The subprogram 6 is run by a user B who directly logs into the subprogram 6 from a keyboard, etc., of the web server terminal 3. The user B directly logging into the subprogram 6 is allowed to alter the setting contents of the printer driver 8 incorporated in the web server terminal 3. The user A, who is logging into the main program 5 from the MFP 2 through the network 1 and via the IIS 7 of the web server terminal 3, cannot make direct access to the subprogram 6. This means that the user B has a user authority for operation of the subprogram 6, and that the main program 5 and the subprogram 6 require respective user authorities different from each other.

Such a case is assumed here that the user A operates the MFP 2 to try to copy a business project of the previous year and that the business project is not in the main program 5 of the web server terminal 3 but is in the file server terminal 4a. In this case, even if a request for copying the business project is input to the MFP 2, the service environment of the IIS 7 restrains the main program 5 from accessing the file server terminal 4a. In the present invention, however, the main program 5 has a function of entrusting the subprogram 6, which is connected to the network not via the IIS 7, with a task of accessing the file server terminal 4a and obtaining information in the file server terminal 4a when the main program 5 has a need to access another server terminal.

The subprogram 6 receiving entrustment of information obtainment from the main program 5 accesses the file server terminal 4a via the network 1 to obtain a file of the business project of the previous year in the file server terminal 4a. The file obtained from the file server terminal 4a is taken into the subprogram 6 via the network 1, and is transformed into print data using the printer driver 8 and delivered to the main program 5, and then is transmitted to the MFP 2. The file may be transformed into print data using the printer driver 8 after being delivered from the subprogram 6 to the main program 5, and then is transmitted to the MFP 2.

Various pieces of information and data obtained by the subprogram 6 entrusted with information obtainment may be scrapped after being used up at the MFP 2, or may be stored on the memory 9 in the web server terminal 3. In principle, the MFP 2 scraps information after using it up, thus not saving the information. Use of the web server terminal 3 is desirable when a need of saving information arises. Even if obtained information is stored on the memory 9, the memory 9 has a limited storage capacity, so that a system for properly checking the storage capacity should desirably be provided.

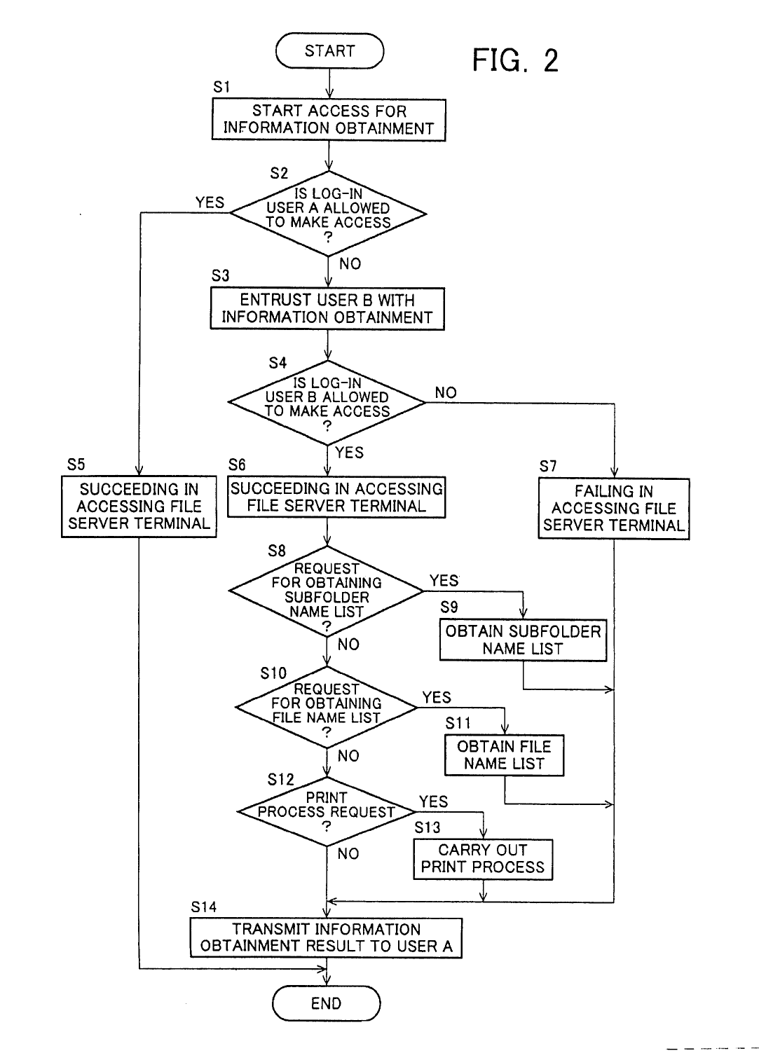

FIG. 2 depicts an example of a process flow of entrustment of information obtainment from the main program 5 to the subprogram 6. At step S1, a request for obtaining given information is sent to the main program 5, which has been started up by logging in from the MFP 2 (log-in user A) via the network 1. When the web server terminal 3 does not contain the requested given information, access is made to other server terminals 4a and 4b connected to the network to see if the given information is present in other server terminals 4a and 4b. In making access to other server terminals via the network, at step S2, a determination is made on whether the log-in user A is allowed to make access from the web server terminal 3 using the IIS. When access is allowed (Yes at step S2), the process flow proceeds to step S5, at which the user A accesses a desired file server terminal, obtains the given information, and then ends the process flow.

When access is not allowed at step S2 (No at step S2), the process flow proceeds to step S3. At step 3, the main program 5 entrusts information obtainment to the subprogram 6 not using the IIS, which subprogram 6 has been started by the log-in user B directly logging into the web server terminal 3. In other words, the main program 5 entrusts information obtainment to the log-in user B. At the next step S4, when access by the user B is not allowed (No at step S4), access to the desired file server terminal is denied at step S7. This denying of access happens in such a case where the user B has not made access-related registration with the server terminal to access, thereby not authenticated by the server terminal. When access is denied to fail in accessing the server terminal, a failure in information obtainment is reported to the user A at step S14, and the process flow is ended.

When access by the user B is allowed at step S4 (Yes at step S4), the process flow proceeds to step S6, at which the user B accesses the desired file server terminal, and the next step follows. When succeeding in accessing the desired file server terminal, the user B searches for specific information to obtain. At step S8, for example, the user B makes a selection on whether or not to make a request for obtaining a list of highest rank subfolder names retained by the file server terminal. When Yes results at step S8, step 9 follows, at which the subfolder name list is obtained.

When No results at step S8, the process flow proceeds to step S10, at which, for example, the user B makes a selection on whether or not to make a request for obtaining a list of file names lower in rank to the subfolder. When Yes results at step S10, step S11 follows, at which the file name list is obtained. When No results at step S10, the process flow proceeds to step S12, at which, for example, the user B makes a selection on whether or not to print out a given file on the file name list. When Yes results at step S12, step S13 follows, at which a process of printing the given file is carried out. When No results at step S12, the absence of desired information in the server terminal is concluded. When the above information obtainment is completed, an information obtainment result is reported to the user A at step S14, and the process flow ends.

While obtaining three pieces of information of the subfolder name list, file name list, and print process request is described in the above process flow, the same process flow obviously enables obtainment of various pieces of information other than those three pieces of information.

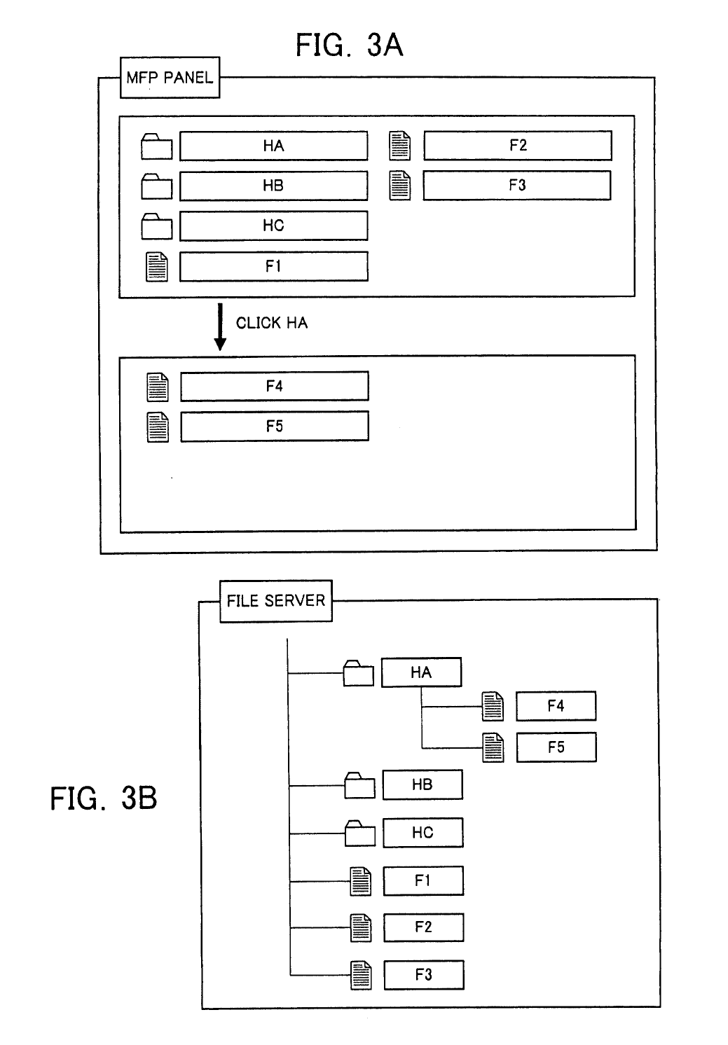

FIGS. 3A and 3B each depict an example of display by the MFP of information from a file server obtained in the above manner. FIG. 3A depicts a specific display form, and FIG. 3B depicts the original information form in the file server.

As shown in FIG. 3B, the information at the file server side consists of a plurality of folders (HA to HC) and a plurality of files (F1 to F5), in which the files (F4 and F5) belong to the folder HA as subordinate elements.

On the display panel of the MFP, for example, the information is displayed in the display form of FIG. 3A by a program of the web server terminal in such a way that the folders (HA to HC) and files (F1 to F3) placed higher in rank at the file server side are placed at the same level with icons. For example, clicking the folder HA on the display panel of the MFP puts the files F4 and F5 subordinate to the folder HA in display on the display panel.

Entrustment of information obtainment from the main program 5 to the subprogram 6 should desirably be carried out on the basis of the XML (Extensible Markup Language) that is now in use as a standard network language. The subprogram 6 receives an XML file from the main program 5, analyzes entrustment contents to write it into a given format, and transmits the entrustment contents to a file server terminal to access. It is desirable that communication between the subprogram 6 and the file server terminal should also be carried out on the basis of the XML. Information obtained from the file server terminal is written into a given format, and is sent in the form of the XML to the main program 5.

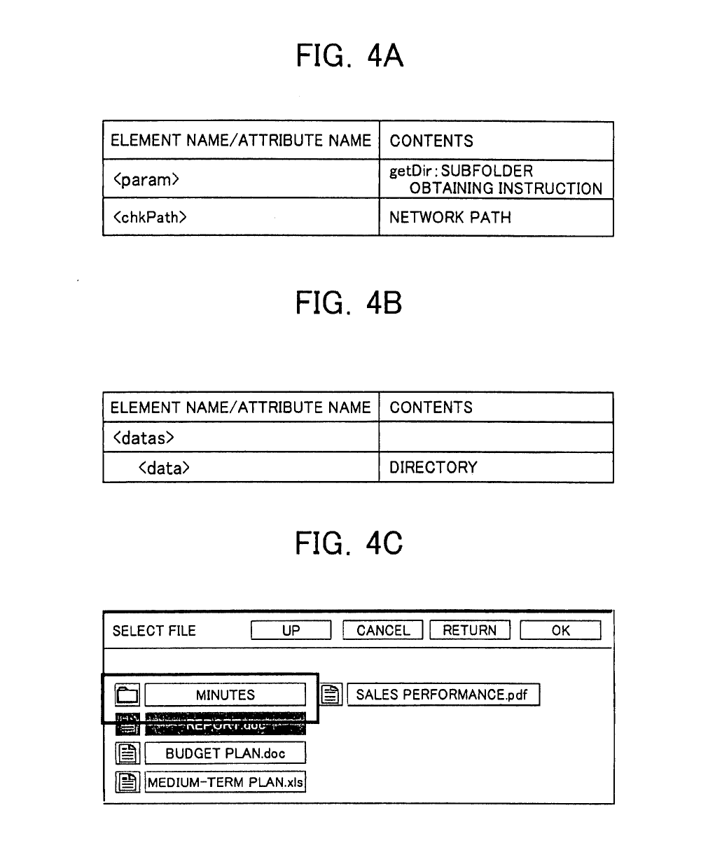

FIGS. 4A to 6 each depict an example of an output format display as described above. FIGS. 4A to 4C each depict an example of a case of obtaining a subfolder name list from a file server terminal. FIG. 4A depicts an example of a command that is used when a subfolder obtaining instruction is sent from the main program 5 to the subprogram 6. The command includes the subfolder obtaining instruction, and a network path to a subfolder in the file server terminal. The table of FIG. 4B is an example of the structure of a subfolder (directory) that is sent from the subprogram 6 to the main program 5. The screen of FIG. 4C is an example of a screen that is sent from the main program 5 to the MFP 2 on the basis of the structure of the subfolder sent from the subprogram 6.

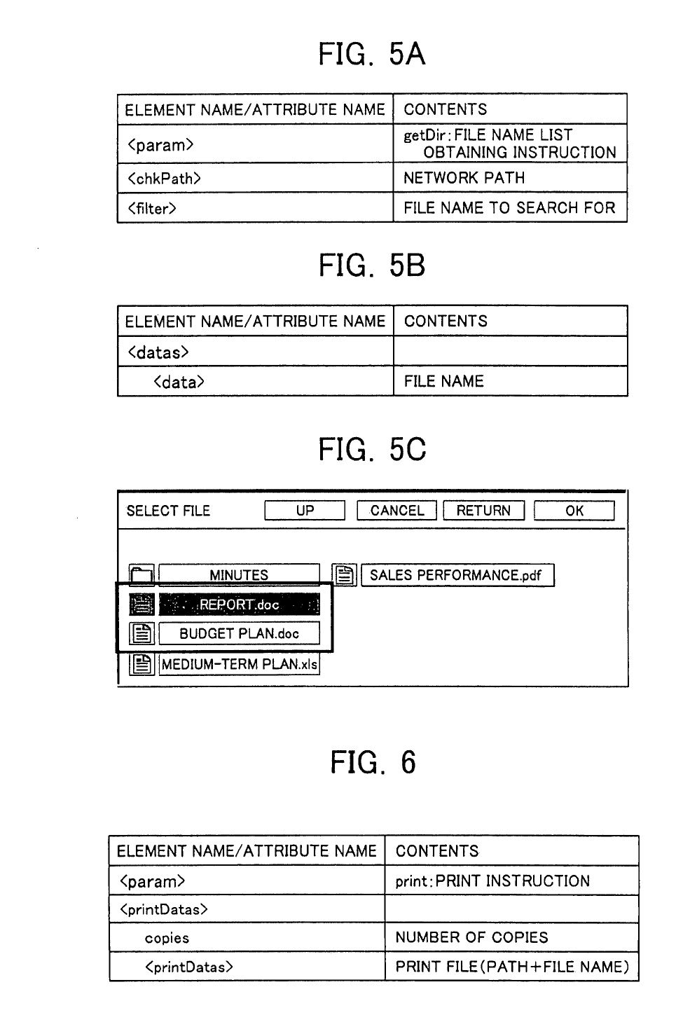

FIGS. 5A to 5C each depict an example of a case of obtaining a file name list. FIG. 5A depicts an example of a command that is used when a file name list obtaining instruction is sent from the main program 5 to the subprogram 6. The command includes the file name list obtaining instruction, and a network path to a file in the file server terminal, and a file name to search for. The table of FIG. 5B is an example of the structure of a file name list (file name) that is sent from the subprogram 6 to the main program 5. The screen of FIG. 5C is an example of a screen that is sent from the main program 5 to the MFP 2 on the basis of the structure of the file name sent from the subprogram 6.

FIG. 6 depicts a display example of an instruction on printing of a specified file, showing an example of a command that is used when a print process instruction is sent from the main program 5 to the subprogram 6. The command includes the print instruction, the number of copies to print, and a network path to a file in the file server terminal and a print file name. In the print process, a file obtained from the file server terminal is received by the subprogram 6 and is sent from the main program 5 through the IIS 7 to the MFP 2, which carries out the print process.

The supplementary description of the operation of the subprogram 6 will be made referring to FIG. 1. As described before, the user B directly logging into the web server terminal 3 is authorized to start the subprogram 6, but the user A logging in from the MFP 2 is not allowed to start the subprogram 6. In addition, the user B logging into the web server terminal 3 is allowed to set up the printer driver 8 and to alter the setup of the printer driver 8 as well, but the user A is not allowed to alter the setup of the printer driver 8.

To allow the user A logging in from the MFP 2 to obtain information not present in the main program 5 from another server terminal, etc., therefore, the user B must be in a log-in state, and if the user B is not in the log-in state, information obtainment by the user A cannot be executed. However, when the user B already in the log-in state puts the subprogram 6 in an operation state in advance, the main program 5 can entrust the subprogram 6 with information obtainment. This allows the main program 5 to obtain information from another server terminal, which information cannot be obtained directly by the main program 5 itself.

The above case is presented on the assumption that the web server terminal 3 has two log-in entrances for two log-in users. However, for example, the power source of the web server terminal 3 may be turned on through remote control carried out by the user logging in from the MFP 2. In this case, the subprogram 6 may be automatically started to be stationed on a permanent basis in operation interlocking with the start of the main program 5 by the log-in user A at the MFP 2. This saves the user A operating the main program 5 at the MFP 2 from a trouble of going to the web server terminal 3 and starting the subprogram 6, and allows the user A to use the main program 5 without being conscious of the subprogram 6.

The present invention enables construction of an information communication system that, through the use of a standard network technology, allows an information apparatus to execute a given process using a program on a web server terminal and to obtain information from another server terminal, the information being originally not available at the web server terminal, to be able to exert more functions.

1. An information communication system allowing an information apparatus to use a program stored on a web server terminal via network connection, wherein
the web server terminal includes a main program running in response to logging in from the information apparatus, and a subprogram running in response to direct logging in from the web server terminal and requiring user authority different from that for the main program, wherein
the main program receives and delivers information using internet server software that is limited in access to another server terminal connected by the network connection, and the subprogram is allowed to make access to the another server terminal without using the internet server software, and wherein
when the main program is incapable of obtaining information stored on the another server terminal, the subprogram is entrusted with obtainment of the information.

2. The information communication system as defined in claim 1, wherein
entrustment of information obtainment to the subprogram is executed as the entrustment is input through the information apparatus and is imparted from the main program to the subprogram.

3. The information communication system as defined in claim 1, wherein
information from the another server terminal obtained via the subprogram is sent from the subprogram through the main program to the information apparatus that uses the information.

4. The information communication system as defined in claim 1, wherein the web server terminal comprises a memory that has stored thereon information from the another server terminal obtained via the subprogram.

5. The information communication system as defined in claim 1, wherein
the subprogram is entrusted with obtainment of a specified subfolder name list in the another server terminal.

6. The information communication system as defined in claim 1, wherein
the subprogram is entrusted with obtainment of a specified file name list in the another server terminal.

7. The information communication system as defined in claim 1, wherein
the subprogram is entrusted with a print process on a specified file in the another server terminal.

8. The information communication system as defined in claim 1, wherein
an XML file is used for reception and delivery of information between the main program and the subprogram.

9. The information communication system as defined in claim 1, wherein
the subprogram is run under an authority of a user directly logging into the web server terminal.

10. The information communication system as defined in claim 1, wherein
the subprogram is automatically stationed on a permanent basis on the web server terminal.
